(19) United States
(12) Patent Application Publication
(10) Pub. No.: US 2025/0368286 A1
(43) Pub. Date: Dec. 4, 2025

(54) System for Increasing Driving Safety When Driving a Motorcycle and Method for Increasing the Driving Safety of a Motorcycle

(71) Applicant: Bayerische Motoren Werke Aktiengesellschaft, Muenchen (DE)

(72) Inventor: Jens BERGER, Muenchen (DE)

(21) Appl. No.: 18/874,131

(22) PCT Filed: Aug. 9, 2023
(86) PCT No.: PCT/EP2023/072005

§ 371 Date: Dec. 12, 2024

(30) Foreign Application Priority Data
Sep. 6, 2022 (DE) 10 2022 122 485.6

(51) Int. Cl. B62J 50/22; B62J 45/415; B62J 45/416; G07C 5/02

(52) U.S. Cl. CPC B62J 50/22; B62J 45/415; B62J 45/416; G07C 5/02

(57) ABSTRACT

A system for increasing driving safety when driving a motorcycle and optimizing the driver behavior of a driver of a motorcycle, includes a detection device that is designed to detect an actual driver behavior as well as vehicle and surroundings information. The detection device is designed to derive a target driver behavior from the vehicle and surroundings information and display said target driver behavior to the driver.

### BACKGROUND AND SUMMARY

The present invention relates to a system for increasing the riding safety when riding a motorcycle and to a method for increasing the riding safety when riding a motorcycle.

In the case of motorcycles, such as motorbikes, the rider posture or seating position takes a prominent position. Motorcycle riders often tend to ride with the wrong posture, especially in curves. This can result in an unfavorable center of mass distribution and restricted maneuverability of the motorcycle. A high safety risk ultimately results from an incorrect rider posture/seating position.

DE 10 2017 200 065 A1 discloses a steering assistance method in a two-wheeled vehicle when cornering, the steering system of which is equipped with a servo unit for generating a steering-assisting servo torque, wherein the current speed and the current inclination are ascertained via a sensor system in the two-wheeled vehicle and the two-wheeled vehicle position is determined via a position determination system, wherein in the event of a deviation of the current inclination from a target inclination corresponding to the curve radius and the current speed, a servo torque is generated in the steering system via the servo unit, which is directed counter to the deviation of the current inclination from the target inclination. Such a steering intervention can be rather unpleasant in particular for unpracticed motorcycle riders, however.

DE 10 2019 202 330 A1 relates to a method for determining the position of an occupant on a vehicle, in which person-related sensor signals are ascertained with the aid of at least one person sensor worn by the occupant and vehicle-related sensor signals are ascertained with the aid of at least one vehicle sensor arranged on the vehicle, wherein the position of the occupant on the vehicle is ascertained as a function of the person-related and the vehicle-related sensor signals. It is therefore possible, for example, to create characteristic curves in an assembly influencing the riding dynamics of the vehicle as a function of the position of the occupant. Furthermore, it is possible, in the event of a seating position of the occupant deviating from the target position, to warn the occupant. This has the disadvantage that the critical situation has also already occurred.

It is therefore an object of the present invention to provide a system for increasing riding safety when riding a motorcycle and a method for increasing riding safety when riding a motorcycle, wherein the known systems and methods are to be refined and adapted.

This object is achieved by a system and by a method according to the independent claim(s). Further advantages and features result from the dependent claims as well as the description and the appended figures.

According to the invention, a system for increasing riding safety when riding a motorcycle comprises a detection device designed to detect an actual rider posture as well as vehicle information and surroundings information, wherein the detection device is designed to derive a target rider posture from the vehicle information and surroundings information, and, according to one embodiment, from the actual rider posture, and display it to the rider. A system is thus advantageously provided in the present case which enables the seating position or rider posture to be optimized. The system thus helps to improve the riding ability of the rider. Hazardous situations can thus advantageously be avoided or in the ideal case do not occur at all. The detection device advantageously enables an actual situation to be recorded or detected.

According to one embodiment, the actual situation comprises the actual rider posture as well as vehicle information and surroundings information. In other words, it is detected what the vehicle is currently doing, what the rider is currently doing, or how the environment or the surroundings appear.

According to one embodiment, the detection device is also designed to detect and/or to analyze a rider status, in particular, for example, to recognize whether the rider is capable of riding or is excessively fatigued, inattentive, or even unconscious, etc. In addition, it is expediently possible to detect whether the rider is seated on the motorcycle, whether the motorcycle lies on the ground, in particular thus whether an accident has taken place or at least threatens. In these cases, the system is expediently designed, in particular automatically or independently and, for example, via a networked (IT) system (in combination with a mobile terminal, such as a smartphone, a corresponding app, etc.), to transmit an emergency call or to bring the vehicle into a safe traveling state.

According to one embodiment, the actual rider posture comprises at least one of the following items of information: head posture, upper body posture, arm posture, shoulder posture, leg posture, seating position on the rider seat (for example, forward, rear, middle), etc.

According to one embodiment, the vehicle information comprises at least one of the following items of information: the angle of inclination of the motorcycle, a steering wheel position, the speed, the center of mass (with and without rider or possibly also passenger), the gas pedal position and/or brake lever or brake pedal position.

According to one embodiment, the surroundings information comprises at least one of the following items of information: route course, route profile, riding line/ideal line, weather, roadway status, and/or hazard messages.

Using the system it is possible, for example, to determine a rider posture optimal for an ideal line. According to one embodiment, the system is designed to display a target rider posture to the rider, which is optimal to achieve or follow the ideal line.

Especially when cornering, for example, there is the possibility of laying down in the curve. This means that the rider and the motorcycle have essentially the same angle of inclination in relation to the roadway plane. In addition, it is possible that the rider hangs in the curve, wherein the rider has a significantly smaller angle of inclination in relation to the roadway plane than the motorcycle. Alternatively, so-called “pressing” is possible, wherein the motorcycle has a smaller angle of inclination in relation to the roadway plane than the rider. The system can expediently specify the ideal target rider posture in the present case depending on the situation.

Furthermore, it is alternatively possible that certain boundary conditions are specified in order to influence the target rider posture in certain ranges. It is thus generally not typical in the case of so-called “supersport bikes” to “press” them. Instead, a rider will tend more to lay or hang in the curve with this type of machine. The system can expediently take the different nuances into consideration.

The system preferably comprises a display, which is designed to display one or more instructions to achieve the target rider posture to a rider. It is thus possible, for example, to display to the rider via the display that they have to lay down still further in the curve. In the same way, it is possible, for example, to display to the rider that the motorcycle has to be pressed further into the curve. In addition, it can be signaled to the rider, for example, that they are seated too far forward, etc.

As a result, the system advantageously enables increasing the rider ability. The deviation between the actual rider posture and the target rider posture ideally becomes smaller and smaller over time.

According to one embodiment, the detection device comprises one or more detection means. Such detection means can comprise sensors, such as image sensors, pressure sensors, inclination sensors, etc., which are designed to detect in particular the actual rider posture, the vehicle information, and the surroundings information. Sensors and data already present in the vehicle electronics in any case can also be used in particular to detect the vehicle information.

According to one embodiment, the system comprises a database, wherein the database comprises additional information for influencing the target rider posture. Such additional information can be, for example, the above-mentioned motorcycle type, thus information as to whether, for example, it is a touring motorcycle, a sport motorcycle, a motor scooter, etc. Additional information can further be historical data which comprise the riding style of the rider. In addition, rider data such as sex, height, weight, etc. can also be comprised.

The invention is furthermore directed to a method for increasing the riding safety when riding a motorcycle, comprising the following steps:
detecting an actual rider posture;
analyzing vehicle information and surroundings information;
deriving a target rider posture from the vehicle information and surroundings information and, according to one embodiment, from the actual rider posture;
displaying the target rider posture to the rider.

The method advantageously enables the rider to assume an optimum riding position on the motorcycle. The rider is assisted when riding. For example, the system or the method assists the rider when riding the curve ideal line and ensures safe operation of the vehicle during acceleration and deceleration operations. The analysis/assistance for optimum rider position/posture with head posture can be coupled with an analysis and recommendation with respect to riding on straight lines and in the curve based on the curve ideal line. The curve ideal line can be created using a simple model based on curve length/angle or optionally can be enriched using a roadway camera and a detailed surroundings model.

The method preferably comprises the following step:
specifying boundary conditions for influencing the target rider posture.

In the method, it can advantageously be taken into consideration how trained the rider is, whether they want to ride more fast or slow, etc. For example, a racetrack mode can be set which is intended for secured routes. In this case, riding as fast as possible in addition to corresponding rider posture are possible target variables. According to one embodiment, it would also be possible to display a speed adjustment, whether upward or downward, to the rider together with the target rider posture.

According to one embodiment, the method comprises the following step:
recording the actual rider posture.

The recording of the actual rider posture expediently enables later analysis and evaluation. It is thus possible, for example, that the actual rider posture is compared later with the target rider posture. The rider can draw possible conclusions therefrom and receives the possibility of improving their riding style further.

The advantages and features mentioned in conjunction with the method also apply accordingly to the system, and vice versa.

Further advantages and features result from the following description of an embodiment of a system or a method with reference to the appended figures.

### BRIEF DESCRIPTION OF THE DRAWINGS

FIG. 1 is a schematic view of a motorcycle with rider to illustrate a mode of operation of an embodiment of the system or the method; and

FIG. 2 is a flow chart to illustrate a mode of operation of an embodiment of the system or the method.

### DETAILED DESCRIPTION OF THE DRAWINGS

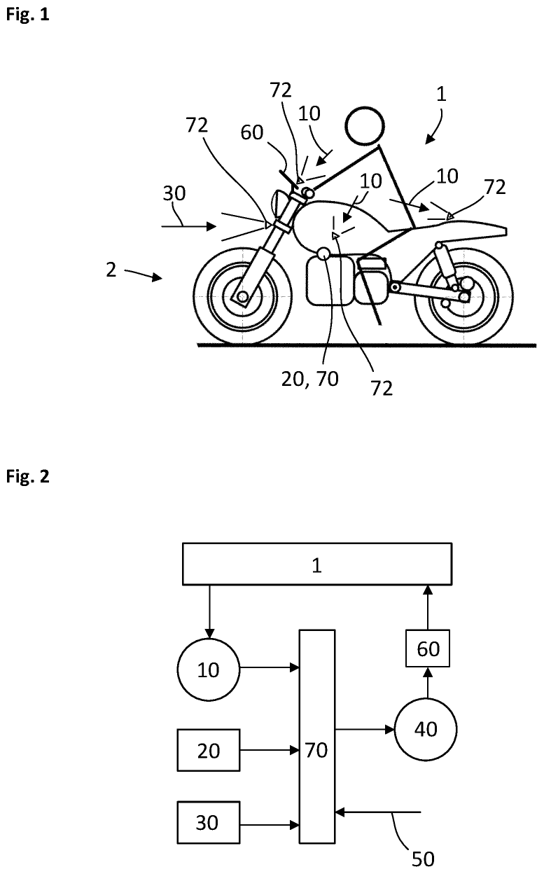

FIG. 1 shows a rider 1, who rides on a motorcycle 2. The motorcycle 2 comprises a system for increasing the riding safety. The system comprises a detection device which is outlined in the present case with the reference sign 70. The detection device 70 comprises a plurality of detectors 72, such as sensors. Some of the detectors 72 are directed on the rider 1 in order to detect an actual rider posture 10. It is also shown that at least one detector 72 is directed forward along a direction of travel of the motorcycle 2 in order to detect, for example, surroundings information 30, such as the route course, etc. The reference sign 20 refers to and designates items of vehicle information which are detected, for example, via the vehicle electronics, such as angle of inclination, speed, current center of mass location, with or without rider 1, etc. The system operates, for example, so that a target rider posture 40 can be calculated or derived from the vehicle information and surroundings information 20, 30 and optionally from the actual rider posture 10. This target rider posture is expediently displayed to the rider 1, wherein a display 60 is provided for this purpose in the present case. It is thus communicated to the rider 1 via the display 60 how they have to adjust their posture in order to meet the curve ideal line, for example. According to one embodiment, at least one camera analyzes the rider 1 and their posture or head posture. A further sensor analyzes, for example, the seating position of the rider 1 on the seat bench, the center of mass (of the motorcycle with rider). An optional roadway camera identifies, for example, the road. According to one embodiment, the system comprises a road and curve model, which is designed to calculate a curve ideal line. The rider posture/position is compared with the road curve model and analyzed. The rider 1 receives proposals via the display 60 for improving their rider posture/position continuously or also after the journey. The system is expediently also designed to communicate with a mobile terminal, such as a smartphone, and to transmit corresponding data. According to one embodiment, it is possible to communicate with a networked (IT) system via the smartphone. The rider status and the presence of an accident can thus expediently be detected and an emergency call can be placed.

FIG. 2 schematically shows a sequence of the method, wherein it becomes clear in particular that the method is an iterative process. A target rider posture 40 is calculated in a detection device 70 from an actual rider posture 10, vehicle information 20, and surroundings information 30. This target rider posture can be communicated via a display 60 to a rider 1, who thereupon optionally corrects their actual rider posture 10. This is detected again, etc. A new target rider posture 40 is calculated from the vehicle information 20 and surroundings information 30 which has changed in the meantime, etc. Reference sign 50 signals that the detection device 70 can be provided with corresponding boundary conditions as data or takes these into consideration. In this case, it can be specified, for example, which motorcycle type it is, whether it is a beginner rider or an advanced rider, etc.

### LIST OF REFERENCE SIGNS

1 rider
2 motorcycle
10 actual rider posture
20 vehicle information
30 surroundings information
40 target rider posture
50 boundary conditions
60 display
70 detection device
72 detectors (sensors)

1.-10. (canceled)

11. A system for increasing riding safety when riding a motorcycle, comprising:
a detection device configured to detect an actual rider posture as well as vehicle information and surroundings information; and
wherein the detection device is further configured to:
derive a target rider posture from the vehicle information and the surroundings information, and
display the target rider posture to the rider.

12. The system according to claim 11, wherein the actual rider posture comprises at least one of the following items of information:
head posture, upper body posture, arm posture, shoulder posture, leg posture, or seating position on a vehicle seat.

13. The system according to claim 12, wherein the vehicle information comprises at least one of the following items of information:
angle of inclination, steering wheel position, speed, center of mass, gas pedal position, and/or brake lever/pedal position.

14. The system according to claim 13, wherein the surroundings information comprises at least one of the following items of information:
route course, route profile, riding line/ideal line, weather, roadway status, and/or hazard messages.

15. The system according to claim 11, wherein the vehicle information comprises at least one of the following items of information:
angle of inclination, steering wheel position, speed, center of mass, gas pedal position, and/or brake lever/pedal position.

16. The system according to claim 11, wherein the surroundings information comprises at least one of the following items of information:
route course, route profile, riding line/ideal line, weather, roadway status, and/or hazard messages.

17. The system according to claim 11, further comprising:
a display that displays one or more instructions to achieve the target rider posture to a rider.

18. The system according to claim 11, wherein the detection device comprises one or more sensors.

19. The system according to claim 11, further comprising:
a database, wherein the database comprises additional information for influencing the target rider posture.

20. A method for increasing riding safety when riding a motorcycle, the method comprising the steps of:
detecting an actual rider posture;
analyzing vehicle information and surroundings information;
deriving a target rider posture from the analyzed vehicle information and surroundings information; and
displaying the target rider posture to the rider.

21. The method according to claim 20, further comprising the step of:
specifying boundary conditions for influencing the target rider posture.

22. The method according to claim 20, further comprising the step of:
recording the actual rider posture.
